(19) United States
(12) Patent Application Publication
(10) Pub. No.: US 2017/0012294 A1
(43) Pub. Date: Jan. 12, 2017

(54) DOPED ELECTRODE AND USES THEREOF

(71) Applicant: NEWCASTLE INNOVATION LIMITED, Callaghan (AU)

(72) Inventor: Scott Donne, Callaghan (AU)

(73) Assignee: NEWCASTLE INNOVATION LIMITED, Callaghan (AU)

(21) Appl. No.: 15/118,029

(22) PCT Filed: Feb. 9, 2015
(86) PCT No.: PCT/AU2015/000069

§ 371 Date: Aug. 10, 2016

(30) Foreign Application Priority Data
Feb. 10, 2014 (AU) 2014900394

(51) Int. Cl. H01M 4/90; H01M 8/14; H01M 4/88; H01M 4/96

(52) U.S. Cl. CPC H01M 4/9016; H01M 4/96; H01M 8/14; H01M 4/8825; H01M 2008/147

(57) ABSTRACT

The present invention relates to the electrochemical behaviour of carbon involving the use of a half cell set-up and solid sacrificial anode. The electrochemical oxidation of a selectively-contaminated graphite electrode has been assessed; the contaminants included anatase, alumina, pyrite, quartz, kaolin and montmorillonite. From the systematic introduction of these contaminants it was discovered that clay materials, such as kaolin and montmorillonite act catalytically to increase the rate of graphite oxidation. This demonstrates a clear effect of the solid phase interaction of contaminants upon the electrochemical oxidation of graphite; the same effect was not observed when the contaminants were added instead to the molten carbonate electrolyte.

### FIELD OF THE INVENTION

The present invention relates to the electo-oxidation of carbon anodes. In particular, the invention relates to the technical effect of strategically contaminating (or doping) such electrodes with common coal foulants such as anatase, alumina, pyrite, quartz, kaolin and montmorillonite.

The results obtained are especially relevant to the field of energy production—and in particular, energy production by way of the direct carbon fuel cell (DCFC) and related technologies. The invention will be described herein with reference to its application in DCFC technologies—however, it will be appreciated by those skilled in the art that the invention is not limited to this particular field of use.

### BACKGROUND OF THE INVENTION

Any discussion of the prior art throughout the specification should in no way be considered as an admission that such prior art is widely known or forms part of common general knowledge in the field.

Fossil fuel-based energy production is neither sustainable nor in good favour with current climatic concerns. Modern energy production is heavily reliant upon fossil fuels such as coal, gas and oil—all of which have strictly finite reserves, and all of which produce emissions such as carbon dioxide (CO₂), nitrogen oxides (NOₓ) and sulfur dioxide (SO₂); these emissions interrupt natural cycles and processes.

Set against these limitations is the fact that global demand for electricity production is increasing almost exponentially. Many current research interests focus on the design and development of new power generation technologies which ideally also act to reduce emissions intensity. One such technology is the Direct Carbon Fuel Cell (DCFC).

The DCFC is not a new technology. Indeed, the first United States patent for such a cell was issued in 1896. The DCFC produces electrical energy through the reduction of oxygen within the cathode of the cell, with oxidation of the carbon fuel source occurring on the anodic side. The cell produces energy by combining carbon and oxygen, which releases carbon dioxide as a by-product. Utilised carbon can be in the form of coal, coke, char, or a non-fossilised source of carbon. Half and full-cell reactions for the DCFC are shown in Equations (1)-(3), below:

C+2O²⁻→CO₂+4e⁻ ANODE (1)

O₂+4e⁻→2O²⁻ CATHODE (2)

C+O₂→CO₂ OVERALL (3)

Fuel cells that operate using solid fuel are capable of providing higher energy densities than those that operate using gaseous fuels. For example, solid carbon contains a high energy density per unit volume (i.e., 20 kWh/L) compared with gaseous and liquid fuels such as methane (4.2 kWh/L), hydrogen (2.4 kWh/L) or diesel (9.8 kWh/L).

In view of the above, recent progress in materials and electrolytic chemistry appear to have recognised this potential. Indeed, such advances have seen the century-old DCFC recently enjoy something of a renaissance in terms of its industrial applicability. Despite the release of carbon dioxide, the DCFC is actually more environmentally-friendly than traditional carbon burning techniques; due to its higher efficiency, it requires less carbon to produce an equivalent amount of energy. Also, because pure carbon dioxide is emitted, carbon capture techniques are comparatively cheaper than for conventional power stations, which must either separate the carbon dioxide from other emitted gases prior to sequestration, or else simply sequester all emitted gases (which can include undesirable products such as oxides of nitrogen and sulfur and particulate matter). As will be appreciated, both options are somewhat less efficient than the facility to trap pure carbon dioxide at its source. The relative purity of the DCFC oxidation products allows simpler sequestration without expensive and energy-intensive separation and purification processes.

At least four types of DCFC exist: the first is based on the solid oxide fuel cell (SOFC) concept; the second is a molten hydroxides fuel cell (see, e.g., U.S. Pat. No. 555,511 from 1896); the third is based on the Molten Carbonate Fuel Cell (MCFC) concept (see, Canadian patent 55,129 from 1897; and the fourth is a molten tin anode solid oxide fuel cell design, which utilises molten tin and tin oxide as an inter-stage reaction between oxidation of the carbon dissolving in the anode and reduction of oxygen at the solid oxide cathode.

DCFCs are a unique type of fuel cell as they have the ability to utilise solid carbon fuel. Coal, a well-known source of amorphous carbon, is used widely in energy production around the world and has been identified as a candidate for use in the DCFC [see, Refs. 1-5]. Carbonaceous material in coal can be transformed directly to electrical energy within the DCFC with high efficiency assuming non-Boudouard conditions, i.e., chemical conversion of carbon through reaction with carbon dioxide at elevated temperatures [see, Refs. 2, 6]. This direct conversion has the potential to increase the electrical conversion efficiency of the energy contained in coal to over 80% (cf. conventional coal-fired power stations, which generally operate below 40% [see, Ref. 1] given that only one energy transformation takes place).

Kinetics and associated limitations in the oxidation reaction of carbon to carbon dioxide under different cell conditions/arrangements have been highlighted recently as important avenues for research pertaining to the DCFC [see, Refs. 1, 7]. There exist a number of cell designs used in recently-published literature that give information on the overall electrochemical performance of different carbon materials and cell components under DCFC conditions [see, Refs. 8-15]. However, a relatively small number of research groups have focused specifically on the anodic oxidation reaction, including analyses of electrochemical processes at the anodic electrode [see, Refs. 3, 16, 17]. Accordingly, the anodic oxidation reaction of the DCFC forms the basis of the present invention.

Methods of optimising the anodic efficiency of a DCFC have been published throughout the patent literature. Of particular note is International Publication WO 2008/118139, to Direct Carbon Technologies, LLC. This publication relates to a catalytic anode comprising doped ruthenates corresponding to the general composition Ai₋ₓA′ₓRuO₃, AB₁.yR.U_{y}O₃, and A₁₋ₓA′_{χ}Bi._{y}RU_{y}O₃, wherein A and A′ are divalent, trivalent, and tetravalent cations and B is a multivalent cation. Good operational efficiency is achieved, however, it will be appreciated that the additional steps required to dope an anode with often rare transition metals creates an added burden upon the operator.

More recently, International Publication WO 2013/061067, to the University of St Andrews, has attracted attention. The disclosure provides for a DCFC system comprising an electrochemical cell, itself comprising a cathode, a solid state first electrolyte and an anode, wherein the system further comprises an anode chamber containing and/or being adapted to receive a second electrolyte and a fuel.

Further examples of DCFCs are described in International Publication WO 2006/061839 and United States Publication US 2006/0019132, both of which describe cells having solid electrolytes and anodes that comprise a fuel and a liquid electrolyte.

Generally-speaking, the patent and indeed the scientific literature regarding the anodic oxidation reaction in a DCFC can be characterised by an apparent desire to chemically modify the anode. There appears to have been little attention paid to investigating the anodic characteristics of naturally-occurring (i.e., already-doped) materials such as coals and cokes; the present invention is in response to this apparent gap in the literature.

It is an object of the present invention to overcome or ameliorate at least one of the disadvantages of the prior art, or to provide a useful alternative.

It is an object of an especially preferred form of the present invention to provide means toward increasing the overall efficiency (i.e., percentage conversion of carbon into electricity) of a DCFC by relatively optimising the anodic oxidation reaction.

The electrochemical oxidation reaction was studied in this work using graphite as a base through the use of a specifically designed electrochemical test cell. The cell was designed in order to enable testing of a solid anode arrangement rather than suspended carbon, which has been used in previous work [see, Refs. 3, 13, 17]. There are a number of drawbacks in investigations using suspended carbon as a basis. Primarily, the mass transfer limitations of a cell mask certain other kinetic behaviours of a particular fuel. Further, if a carbon source artificially contaminated with mineral matter is suspended and stirred within a molten salt (electrolyte) over any period, it is likely that the contaminant phase will interact with the molten salt. However, it has been assumed previously that mineral matter remains a part of the carbon material and affects the reactions on the surface of the particle [see, Ref. 3].

Graphitic carbon was chosen as the anode for the inventive study as it represents significantly less variability in carbon type, surface functionalities, ash content, chemistry and general physical and chemical behaviour compared to other carbon materials tested for use in the DCFC [see, Refs. 8, 16, 18]. The basic oxidative behaviour of graphite was first established in order to compare the effect of different contaminants on the oxidation of graphitic carbon.

Contaminants for investigation were chosen based on those typically present in samples of Australian black (i.e., bituminous) coal. Such coal is typically mined in Queensland and New South Wales, and is used for both domestic power generation and for export. Australian black coal contains a significant amount of mineral matter, commonly in the form of clays, mixed metal/non-metal oxides and pyrite, some of which have been shown to affect the electrochemical oxidation of carbon within test DCFC cells in the form of coal ash [see, Ref. 19]. In that work, four Australian sub-bituminous coals and an American coking coal were analysed using XRD to identify mineral phases which exist in significant concentration within the particular coals studied. Special care was taken to identify contaminants present in the coal as these will, in turn, be introduced to a DCFC system (rather those identified following high temperature ashing, which is known to affect the chemical structure of contaminants and coals [see, Refs. 20-22]).

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As applied herein, the term “dope” and variants thereof is intended to convey “contaminated”, or “selectively contaminated”. Selective contamination means that the carbon electrodes of the present invention have been modified deliberately with foreign species, cf. natural contamination, such as one would encounter with coal. Accordingly, “dope”, “doped”, “dopant” and the like are used in a context that requires that the contaminant species is added deliberately to improve its performance above and beyond what the natural contaminants would achieve.

Although the invention will be described with reference to specific examples it will be appreciated by those skilled in the art that the invention may be embodied in many other forms.

As used herein, DCFCs are electrochemical cells in which carbon is used as a fuel that is, in turn, oxidised electrochemically by an oxidant on the anodes. The use of the term “direct” herein does not mean one elementary reaction step, but instead is used as being indicative of direct conversion of the fuel in one process, i.e., without external processes such as cracking. For example, the direct reaction may include gasification and fuel cell reactions in one chamber. Furthermore, although the term “fuel cell” is used, it will be appreciated that the electrochemical cell need not be continuously replenished with fuel and/or oxidant. It will be further appreciated that at least one of the anode and/or the cathode sides of the cell may be operated using a batch process or single use process more akin to a battery.

### SUMMARY OF THE INVENTION

The invention relates generally to a method of examining the fundamental electrochemical behaviour of carbon, involving the use of a half cell set-up and a solid sacrificial anode. Using this method, the electrochemical oxidation of carbon has been assessed using selective contamination of a carbon electrode with dopants common to Australian black coals. Contaminants identified include anatase, alumina, pyrite, quartz, kaolin and montmorillonite. From the systematic introduction of these contaminants, it has been discovered that clay materials, such as kaolin (e.g., Al₂Si₂O₅(OH)₄) and montmorillonite (e.g., (Na,Ca)_{0.33}(Al,Mg)₂(Si₄O₁₀)(OH)₂.nH₂O) act catalytically to increase the rate of carbon oxidation. On the other hand, metal oxides and sulfides such as anatase (TiO₂), alumina (Al₂O₃) and pyrite (FeS₂, “fool's gold”) gave a limited increase in the normalised current, whereas quartz (SiO₂) gave rise to a significant decrease in performance. The same effects were not observed when these contaminants were added instead to the molten carbonate electrolyte; these results demonstrate the clear effect of the solid phase interaction of these contaminants on the electrochemical oxidation of carbon.

According to a first aspect of the present invention there is provided use of a dopant selected from the group consisting of kaolin, montmorillonite, alumina, anatase and pyrite for incorporation within a solid carbon working electrode, for the enhancement of anodic oxidation within an electrochemical half cell.

In a preferred embodiment, the electrochemical half cell is resident within a direct carbon fuel cell (DCFC), the anodic oxidation therefore being of the carbon working electrode.

In an embodiment, the dopant and the carbon are substantially catalytic in their oxidative enhancement. Preferably, the carbon is in the form of graphite.

In an embodiment, the enhancement is a function of both the relative proportion of the dopant and the degree of physical contact between the carbon and dopant phases. The degree of physical contact between the carbon and dopant phases is a function of the homogeneity of the mixing between the phases and/or any pre-treatment of the dopant phase.

In a preferred embodiment, the relative proportion of the dopant is between about 10 wt. % to about 50 wt. %.

Preferably, the dopant is kaolin or montmorillonite. Most preferably, the dopant is kaolin. In another preferred embodiment, the kaolin is pre-treated by heating at approximately 500° C. for approximately 30 minutes prior to pelleting, so as to mitigate against possible mechanical damage to the resultant pellets as a result of dehydroxylation of kaolin to metakaolin under half cell conditions.

Most preferably, the wherein the pre-treated kaolin is present in substantially >30 wt. %, and wherein the potential is relatively low (e.g., 0.2 V vs. C/CO₂/CO₃²⁻), thereby to provide for an oxidative enhancement of the order of 45-50 mA cm⁻².

According to a second aspect of the present invention there is provided use of a quartz dopant for incorporation within a solid carbon working electrode, for the inhibition of anodic oxidation within an electrochemical half cell.

In an embodiment, the inhibition tends toward substantial completion as the electrical potential increases.

Preferably, the inhibition is a function of both the relative proportion of the quartz dopant and the degree of physical contact between the carbon and dopant phases. In an embodiment, the degree of physical contact between the carbon and quartz dopant phases is a function of the homogeneity of the mixing between the phases.

In a preferred embodiment, the relative proportion of the dopant is between about 10 wt. % to about 50 wt. %.

According to a third aspect of the present invention there is provided a solid carbon working electrode for incorporation within an electrochemical half cell, the electrode being doped with a dopant selected from the group consisting of kaolin, montmorillonite, alumina, anatase and pyrite, thereby to provide for an enhancement of anodic oxidation within the half cell.

In a preferred embodiment, the electrochemical half cell is resident within a direct carbon fuel cell (DCFC), the anodic oxidation therefore being of the carbon working electrode.

In an embodiment, the dopant and the carbon are substantially catalytic in their oxidative enhancement. Preferably, the carbon is in the form of graphite.

In an embodiment, the enhancement is a function of both the relative proportion of the dopant and the degree of physical contact between the carbon and dopant phases. The degree of physical contact between the carbon and dopant phases is a function of the homogeneity of the mixing between the phases and/or any pre-treatment of the dopant phase.

In a preferred embodiment, the relative proportion of the dopant is between about 10 wt. % to about 50 wt. %. Any variation within the general range of about 10 to about 50 wt. % is considered within the scope of the present invention. For example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 and 50 wt. % are all contemplated, as are intermediary values such as 20.5, 21.5, 22.5, 23.5, 24.5, 25.5, 26.5, 27.5, 28.5, 29.5, 30.5, 31.5, 32.5, 33.5, 34.5, 35.5, 36.5, 37.5, 38.5 and 39.5 wt. %.

Preferably, the dopant is kaolin or montmorillonite. Most preferably, the dopant is kaolin. In another preferred embodiment, the kaolin is pre-treated by heating at approximately 500° C. for approximately 30 minutes prior to pelleting, so as to mitigate against possible mechanical damage to the resultant pellets as a result of dehydroxylation of kaolin to metakaolin under half cell conditions.

Most preferably, the wherein the pre-treated kaolin is present in substantially >30 wt. %, and wherein the potential is relatively low (e.g., 0.2 V vs. C/CO₂/CO₃²⁻), thereby to provide for an oxidative enhancement of the order of 45-50 mA cm⁻².

According to a fourth aspect of the present invention there is provided a solid carbon working electrode for incorporation within an electrochemical half cell, the electrode being doped with quartz, thereby to provide for an inhibition of anodic oxidation within the half cell.

In an embodiment, the inhibition tends toward substantial completion as the electrical potential increases.

Preferably, the inhibition is a function of both the relative proportion of the quartz dopant and the degree of physical contact between the carbon and dopant phases. In an embodiment, the degree of physical contact between the carbon and quartz dopant phases is a function of the homogeneity of the mixing between the phases.

In a preferred embodiment, the relative proportion of the dopant is between about 10 wt. % to about 50 wt. %.

According to a fifth aspect of the present invention there is provided a method of enhancing the efficiency of a direct carbon fuel cell (DCFC), the method comprising incorporating within the anodic half cell of the DCFC a solid carbon working electrode doped with a dopant selected from the group consisting of kaolin, montmorillonite, alumina, anatase and pyrite.

In a preferred embodiment, the electrochemical half cell is resident within a direct carbon fuel cell (DCFC), the anodic oxidation therefore being of the carbon working electrode.

In an embodiment, the dopant and the carbon are substantially catalytic in their oxidative enhancement. Preferably, the carbon is in the form of graphite.

In an embodiment, the enhancement is a function of both the relative proportion of the dopant and the degree of physical contact between the carbon and dopant phases. The degree of physical contact between the carbon and dopant phases is a function of the homogeneity of the mixing between the phases and/or any pre-treatment of the dopant phase.

In a preferred embodiment, the relative proportion of the dopant is between about 10 wt. % to about 50 wt. %.

Preferably, the dopant is kaolin or montmorillonite. Most preferably, the dopant is kaolin. In another preferred embodiment, the kaolin is pre-treated by heating at approximately 500° C. for approximately 30 minutes prior to pelleting, so as to mitigate against possible mechanical damage to the resultant pellets as a result of dehydroxylation of kaolin to metakaolin under half cell conditions.

Most preferably, the wherein the pre-treated kaolin is present in substantially >30 wt. %, and wherein the potential is relatively low (e.g., 0.2 V vs. C/CO₂/CO₃²⁻), thereby to provide for an oxidative enhancement of the order of 45-50 mA cm⁻².

According to a sixth aspect of the present invention there is provided a method of inhibiting the efficiency of a direct carbon fuel cell (DCFC), the method comprising incorporating within the anodic half cell of the DCFC a solid carbon working electrode doped with quartz.

In an embodiment, the inhibition tends toward substantial completion as the electrical potential increases.

Preferably, the inhibition is a function of both the relative proportion of the quartz dopant and the degree of physical contact between the carbon and dopant phases. In an embodiment, the degree of physical contact between the carbon and quartz dopant phases is a function of the homogeneity of the mixing between the phases.

In a preferred embodiment, the relative proportion of the dopant is between about 10 wt. % to about 50 wt. %.

According to a seventh aspect of the present invention there is provided a method of preparing a doped solid carbon electrode for use within an anodic half cell of a direct carbon fuel cell (DCFC), the method comprising grinding the solid carbon with a dopant selected from the group consisting of kaolin, montmorillonite, alumina, anatase, pyrite and quartz; and pelleting the resultant ground mixture.

Preferably, the carbon is in the form of graphite. In a preferred embodiment, the dopant is present within the doped electrode in an amount of about 10 wt. % to about 50 wt. %.

In an embodiment, the method further comprises a pre-treatment step, the pre-treatment step comprising heating the dopant at approximately 500° C. for approximately 30 minutes prior to pelleting.

Most preferably, the dopant is kaolin. In a preferred embodiment, the kaolin is pre-treated by heating at approximately 500° C. for approximately 30 minutes prior to pelleting, so as to mitigate against possible mechanical damage to the resultant pellets as a result of dehydroxylation of kaolin to metakaolin under half cell conditions.

According to an eighth aspect of the present invention there is provided a doped solid carbon electrode when prepared by a method as defined according to the seventh aspect of the present invention.

In the following Examples, the maximum dopant concentration trialled is 50 wt. %. However, higher dopant concentrations are contemplated by the present Inventors. Without wishing to be constrained by theory, the Inventors postulate that with more contaminant being added, the utilisation of the carbon oxidation process would increase, ultimately to the point where as even more contaminant is added, there will not be sufficient carbon present to increase the current any further. Thus, a maximum in current density would be observed, at which point the reconciliation between efficiency and total current would have been reached. From a practical perspective though, more contaminant added to the electrode would ultimately mean more contaminant in the electrolyte after oxidation has been effected. This would have implications on the practical use of the DCFC—and in particular, electrolyte regeneration. On the other hand, solubilisation of these species into the electrolyte actually has potential advantages such that one could use this contaminated electrolyte as a source of species such as aluminum, silicon, etc., from which one could electrodeposit out the solubilised contaminant (in a separate cell) and extract these species in pure form; and at the same time regenerate the electrolyte for use in the DCFC.

### BRIEF DESCRIPTION OF THE FIGURES

A preferred embodiment of the invention will now be described, by way of example only, with reference to the accompanying drawings in which:

FIG. 1 is a general arrangement diagram of the electrode. Contact to the carbon pellet was made through a chromel wire cemented in place with a conductive ceramic adhesive (Resbond 989, mixed with 15 wt. % graphite). The carbon pellet and contact were mounted into a ceramic tube, cemented and cured in place. In FIG. 1, the chromel conductive wire is designated (1), the alumina tube (2), the ceramic glue (3), the conductive ceramic glue (4), and the working electrode pellet (5).

FIG. 2 is a schematic of the test cell design and setup. A three-electrode high temperature electrochemical test cell was manufactured for the purpose of testing the pellets in a molten carbonate eutectic electrolyte. The cell consisted of a circular ceramic dish with a machined flat top, and a specially manufactured ceramic tile lid to allow the working (WE), reference (RE) and counter (CE) electrodes to be held securely in place. A constant carbon dioxide atmosphere was maintained within the cell via an external gas feed line flowing at a rate of 50 mL_{N}/min.

FIG. 3 shows the XRD spectra for [A] raw coal and [B] LTA residues (κ—kaolin, θ—quartz, π—pyrite).

FIG. 4 shows a linear sweep voltammogram plot of current density versus potential for the graphite anode. Repeated LSV scans were performed on a graphite (pure) electrode at 5 mV/s with 60 second interval between scans. Each plot is almost identical, indicating that the electrochemical behaviour using a graphite solid anode is reproducible and consistent over multiple scans.

FIG. 5 shows the electrochemical test results of replicate graphite working electrodes showing open circuit potential (right axis) and current density at 0.3 V vs. C/CO₂/CO₃²⁻ (left axis). The results from electrodes manufactured from the same carbon source gave reproducible and consistent results; this is despite possible small deviations in the final surface topography which may result from the manual electrode preparation method used.

FIG. 6 shows the electrochemical response for graphite contaminated with [A] kaolin, [B] montmorillonite, [C] alumina [D] anatase, [E] pyrite, and [F] quartz. Results for all contaminants tested with various contaminant loadings are shown. As the amount of contaminant increases, the active area available for electrochemical oxidation decreases and therefore the reaction occurs on a reduced surface area (contaminants are assumed to be electrochemically inactive in the potential range investigated).

FIG. 7 shows the comparative performance of graphite incorporated with different contaminants with current density measured at [A] 0.0 V vs. C/CO₂/CO₃²⁻ and [B] 0.2 V vs. C/CO₂/CO₃²⁻.

FIG. 8 depicts Scanning Electron Microscopy (SEM) images (500× magnification) of working electrode surface prior to use with 50 wt. % contamination of [A] kaolin, [B] alumina, [C] anatase, [D] pyrite and [E] quartz. Areas identified as graphite are indicated with a “G” while contaminant areas are indicated with a “C”. The results show some differences in the distribution of contaminants within the graphite electrode.

FIG. 9 is a linear sweep voltammogram performed on the SFG15 graphite electrode pellet using a 5 mV/s scan rate. The region of interest is highlighted. This observation (in the 0.12-0.19 V region) indicates another oxidative process is occurring at the electrode surface. Following this peak a discernible decrease in the normalised current response was observed.

### EXPERIMENTAL PROCEDURES

### Coal Characterisation and Treatment

### a) Proximate Analysis of Coals Investigated

Proximate analysis on the coal materials used the method ATSM D3175-11. Ash analysis was also performed on the coals using ASTM D4326-11.

### b) Low Temperature Ashing

Low temperature ashing was performed in an oxygen plasma low-temperature asher (PE100 Plasma Etch) with a RF power supply providing 200-240 W at frequencies necessary to provide a sustained oxygen plasma (˜13.65 MHz). Selected, pre-dried (at 95° C.), 20-30 g samples were evenly distributed on 150 mm Pyrex dishes and loaded into the ashing chamber, which was then evacuated to 0.15 Torr. Maintenance of the low-pressure oxygen (BOC industrial grade) atmosphere was through a bleed line (5-30 mL/min) and a scavenging vacuum pump. Samples were re-weighed and gently overturned every 48 hour period. Ashing was assumed complete when the mass loss was no greater than 5 mg after a 48 hour cycle, complete ashing was observed after 3 weeks. After completion, samples were sealed in airtight containers until further analysis.

### c) Structural Analysis

X-ray diffraction (XRD) patterns for selected samples were recorded using a Phillips PW1710 diffractometer. CuK_{α} radiation (1.5418 Å) was used to analyse the sample at room temperature using settings of 40 mA and 40 kV, 2θ range of 10°-90°, step size of 0.05° 2θ, scan step time of 2 seconds; the divergence slit-receiving slit-scatter slit widths were 1°-0.2°-1°, respectively.

### d) Morphological Analysis

SEM of manufactured electrode surfaces was carried out. To enable microscopic examination of the pelleted carbon samples, a polished specimen was prepared. This was achieved by initially mounting the carbon pellets under pressure in a two-part, cold setting, epoxy resin. The sample was then ground using various grades of silicon carbide paper on a rotating turntable and finally polished using diamond and silica compounds. This resulted in a relatively flat, representative cross-section, making microscopic examination possible. For SEM examination the sample was mounted on an aluminum stub and carbon evaporation was carried out with a 20 nm conductive layer of carbon suitable for imaging and elemental X-ray analysis. SEM images were taken on a Zeiss MA15 instrument with a silicon drift X-ray detector (SDD) and a back-scattered electron (BSE) detector.

### Working Electrode Fabrication and Selective Contamination

### a) Graphite Pellet Preparation

Graphite (SFG15; Timcal Timrex®) pellets were manufactured in a 13 mm diameter pellet press and compressed at 740 MPa for 5 minutes. To ensure stability under test conditions, the graphite pellets were then sintered for 4 hours under a nitrogen atmosphere at 500° C. with no observable changes in appearance or mechanical strength. Following sintering, the resistivity of the graphite pellets was measured and found to range from 8.0-9.3 μΩm.

### b) Contaminated Graphite Pellet Preparation

The particle size of the contaminants was kept below a standard size by dry-milling the mineral phases and passing them through a 40 μm test sieve prior to mixing with the graphite material. Kaolin was further heat treated at 500° C. for 30 minutes prior to pelletising in order to minimise possible mechanical damage to pellets during electrochemical testing as a result of dehydroxylation of kaolin to metakaolin at elevated temperatures [see, Ref. 23].

After sieving, contaminants were slowly introduced to the graphite powder while mixing in a mortar and pestle and combined for a further 5 minutes or until a homogenous powder was produced. Pellets were then prepared identically to pure graphite.

Contaminant materials including alumina (Al₂O₃), quartz (SiO₂) and anatase (TiO₂) were sourced from Sigma Aldrich, while kaolin, montmorillonite and pyrite were sourced from mineral deposits in the Hunter Valley region of New South Wales, Australia. To confirm the identity and the purity of the contaminant mineral phases sourced, all contaminants were analysed by XRD. All materials were found to match pure references of the material (found in Inorganic Crystal Structure Database) with minor deviations. Deviations observed include the presence of a very minor rutile phase within the anatase and minor traces of quartz in the pyrite material.

### c) Electrode Construction

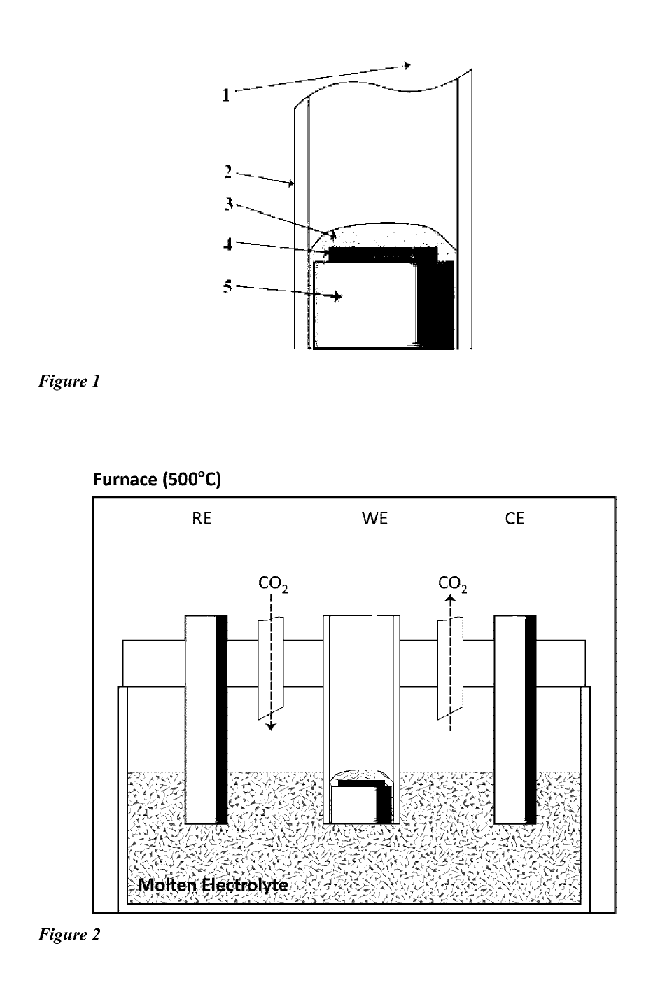

Contact to the carbon pellet was made through a chromel wire cemented in place with a conductive ceramic adhesive (Resbond 989, mixed with 15 wt. % graphite). The conductive adhesive, pellet and wire contact were allowed to dry at room temperature for 4 hours after which they were heated in a nitrogen atmosphere to 90° C., 120° C. and 300° C. for 2 hours, 1 hour and 1 hour, respectively, to dry, cure and post cure the adhesive. The carbon pellet and contact were then mounted into a ceramic tube, cemented and cured in place using ceramic adhesive (Resbond 989) using the same procedure as the conductive glue curing. A general arrangement diagram of the electrode is shown in FIG. 1.

The surface of the working electrode was polished flat on 1000 grit carbide abrasive paper and well rinsed with Milli-Q water to remove any surface contaminant. This procedure produced a working electrode with a cross sectional geometric area of 1.766 cm² (allowing for surface roughness), which has been used to normalise currents recorded in electrochemical testing (along with normalisation used for active carbon surface area as discussed, below).

### Electrochemical Cell Set-Up and Testing

Electrochemical experimentation conducted in this work was performed using an EG&G Princeton Applied Research (PAR) 273A Potentiostat/Galvanostat. M270 electrochemical research software was supplied by PAR to control the potentiostat/galvanostat through a National Instruments high speed-USB general purpose interface bus (GPIB-USB-HS).

### a) Electrochemical Arrangement

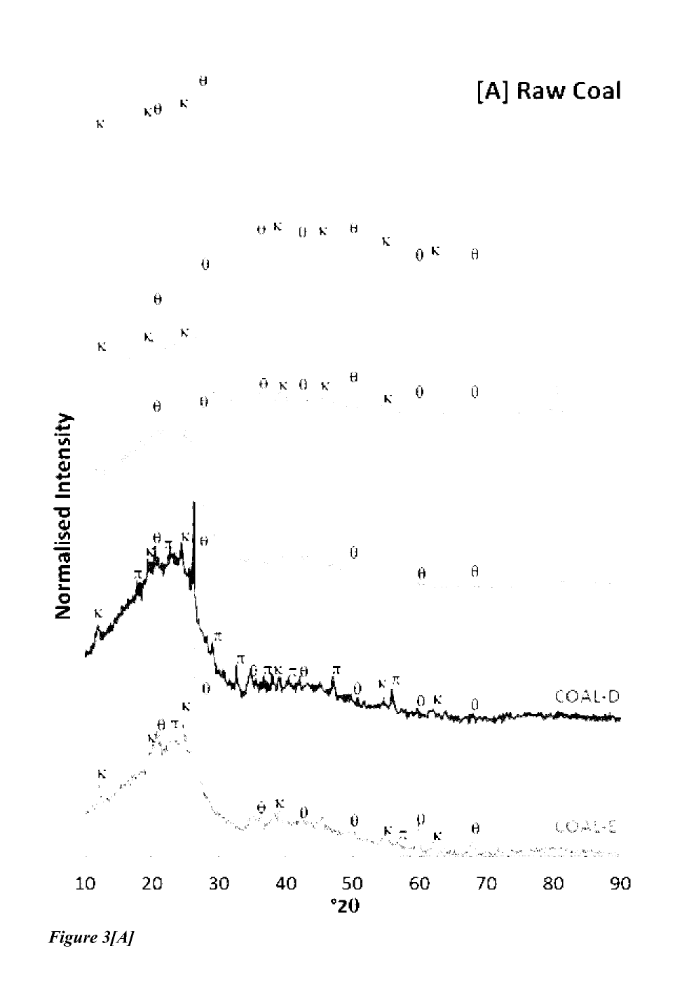

A three-electrode high temperature electrochemical test cell was manufactured for the purpose of testing the pellets in a molten carbonate eutectic electrolyte. The cell was constructed of high-density alumina (ceramic), prepared and machined by Ceramic Oxide Fabricators (Australia). The cell consisted of a circular ceramic dish with a machined flat top, and a specially manufactured ceramic tile lid to allow the working (WE), reference (RE) and counter (CE) electrodes to be held securely in place. A constant carbon dioxide (BOC Grade 4.5) atmosphere was maintained within the cell via an external gas feed line flowing at a rate of 50 mL_{N}/min in order to maintain constant reference electrode conditions. A temperature of 500° C. was used for all experiments. A schematic test cell design and setup is shown in FIG. 2.

### b) Electrodes

The counter electrode (designated “CE” in FIG. 2) consisted of a graphite rod (GrafTech) with electrical contact through an internally cemented chromel wire (conductive ceramic adhesive and curing regime as above). The graphite electrode was cleaned in 30% HNO₃, rinsed with Milli-Q water and heated to 500° C. under nitrogen to remove any residues from manufacture. The geometric surface area of the counter electrode was approximately 3.7 times that of the working electrode (based on an electrolyte depth of 15 mm), ensuring that any surface area limitations were not a result of the counter electrode.

### c) Tertiary Carbonate Electrolyte

Sodium carbonate (Na₂CO₃), lithium carbonate (Li₂CO₃) and potassium carbonate (K₂CO₃) (Sigma >99% pure) were dried at 110° C. under vacuum for 24 hours prior to combining. The three carbonate powders were combined in a mole ratio of 43.5% Li, 31.5% Na, 25% K (m.p. 397° C. [see, Ref. 24]) and gently milled with a mortar and pestle for 5 minutes. The tertiary carbonate precursor was then redried at 110° C. for 1 hour and treated at 450° C. for 30 minutes in a platinum crucible under a CO₂ (BOC Grade 4.5) atmosphere to form the three component eutectic.

### Proximate and Ash Analysis Results

Table 1 summarises the results from the proximate analysis of the five coal samples on a dry basis. Proximate analysis on the coal materials used the method ATSM D3175-11. Ash analysis was also performed using ASTM D4326-11.

TABLE 1
Proximate analysis of five samples of Australian
coal (wt. % on a dry basis)

| | Ash | Volatile matter | Fixed carbon |
|---|---|---|---|
| Sample | [wt. % (db)] | [wt. % (db)] | [wt. % (db)] |
| COAL-A | 10.1 | 35.3 | 54.6 |
| COAL-B | 8.7 | 34.9 | 56.4 |
| COAL-C | 2.3 | 35.1 | 62.6 |
| COAL-D | 9.3 | 37.9 | 52.8 |
| COAL-E | 11.5 | 34.2 | 54.3 |

From the low ash content and high fixed carbon evident from the proximate analysis it is clear that the “COAL-C” sample has been processed to remove some of the ash producing phases. All of the other coal materials showed typical proximate analysis results for sub-bituminous coals.

As is commonplace, the elemental composition of the coal ashes were reported as oxides with composition indicated on a weight percentage basis, results shown in Table 2.

TABLE 2
Ash constituent analysis of coals

| | SiO₂ | Al₂O₃ | Fe₂O₃ | TiO₂ | Na₂O | CaO | SO₃ | K₂O | MgO |
|---|---|---|---|---|---|---|---|---|---|
| COAL-A | 56.5 | 27.6 | 6.4 | 1.4 | 1.3 | 1.5 | 2.1 | 1.2 | 0.9 |
| COAL-B | 58.2 | 27.4 | 4.6 | 1.3 | 3.8 | 0.9 | 1.2 | 1.5 | 0.8 |
| COAL-C | 73.5 | 14.8 | 1.7 | 4.8 | 0.6 | 0.6 | 0.2 | 1.1 | 0.4 |
| COAL-D | 41.6 | 23.5 | 20.3 | 1.1 | 0.8 | 5.4 | 3.5 | 1.7 | 1 |
| COAL-E | 72.4 | 14.6 | 5.8 | 0.1 | 3.6 | 0.9 | 1.2 | 0.6 | 0.7 |

The results shown in Table 2 suggest all coal ashes are dominated by silica with significant inclusion of alumina and ferric oxides. Other constituents are minor and combined consist of less than ten per cent of the total ash. COAL-C again is shown to be different from other coals with notably smaller concentrations of silica, alumina and iron oxides, suggesting a preferential removal of these species in the pre-treatment process.

### Identification of Coal Mineral Phases of Interest

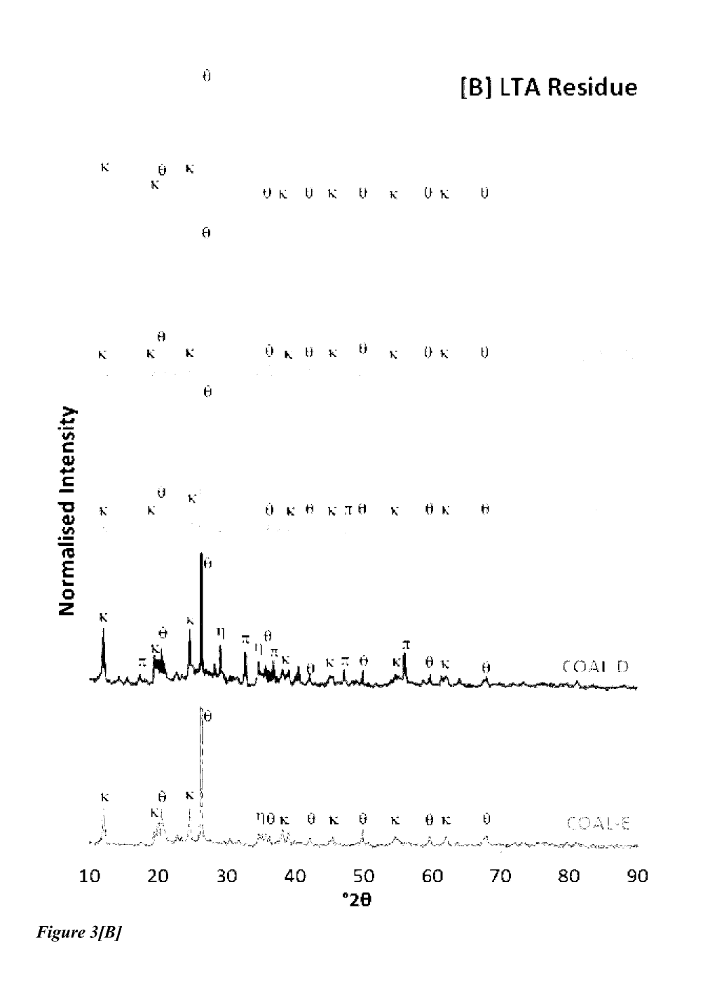

Raw coals (proximate analysis provided in Table 1) were analysed using XRD. Results are shown in FIG. 3[A] along with XRD patterns for coals which have undergone the low temperature ashing (“LTA”) procedure outlined above (see, FIG. 3[B]).

All of the raw coal materials show two broad peaks in the range 10-30°2θ and 30-60°2θ, which are known to be characteristic of poorly crystalline carbon materials [see, Refs. 3, 25]. Superimposed on the broad carbon peak there are several peaks from the crystalline mineral matter in the raw coal samples; namely kaolin (denoted with κ in FIG. 3) and quartz (denoted by θ in FIG. 3), with kaolin peaks at 12.1°2θ, 24.5°2θ and distinct multiple peaks at 20.5°2θ. The peaks due to quartz, 20.45°2θ and 26.4°2θ, are distinct for all the raw coal materials with the main quartz peak, 20.45°2θ, giving the largest peak in all the raw coal patterns.

This peak from the quartz phase is exaggerated somewhat as the graphitic carbon in the coal material also has a main peak at 26.15°2θ. However, the secondary peaks at 49.3°2θ and 59.4°2θ confirm the presence of the quartz phase in the raw coals. In the case of COAL-D, these secondary quartz peaks are minor peaks in the background, likely due to the fact that the majority of the quartz in the COAL-D raw coal is tied up in the clay materials in the sample. The XRD pattern of the raw COAL-D sample also showed small peaks at 32.55°, 36.5°, 40.35°, 46.95° and 55.8°2θ, which are the distinct major peaks from a pyrite (denoted with π) phase in the raw coal.

The large amorphous carbon peaks in the pattern can overshadow many peaks from other mineral phases, meaning detailed information on the mineral phases present in the sample is difficult to establish. LTA was used to remove the carbon material in coal whilst preserving the mineral phases present in the samples through significantly reducing the severity of the ashing temperature and oxidative conditions. XRD patterns from LTA residues collected for each coal sample are shown in FIG. 3[B].

The low temperature ash XRD patterns closely resemble that of their parent coal material with the shadowing broad carbon distortion removed. All of the patterns show strong kaolin peaks at 12.1°2θ and 24.7°2θ and multiple peaks at 19.9°2θ and 38.1°2θ. A large quartz peak can be observed clearly at 26.4°2θ and minor peaks at 20.5°, 36.1°, 49.8° and 67.5°2θ are also evident. It is apparent from these features that the low temperature ashing has not disrupted the mineral phases present in the coal samples.

In comparing the COAL-C and COAL-E raw coal and LTA residue XRD results, it was apparent that the beneficiation process used on the COAL-C sample, whilst decreasing the overall mineral content of the coal sample, shows preference for the removal of certain phases. Evidence for this is the lack of any well-defined clay (kaolin) peaks in the COAL-C pattern, along with the significant reduction in peak height from the quartz mineral phase. From the proximate analysis the COAL-C and COAL-E coals both showed a high Si:Al ratio, indicating that there was likely to be a higher quartz phase present in these samples. COAL-E shows strong primary and secondary peaks from a quartz phase, whereas the secondary quartz peaks are almost lost in the background for the COAL-C raw coal spectra. From the XPert analysis software, only quartz and polymorphic graphite were identified in COAL-C.

TABLE 3
Identified mineral phases in the LTA samples of some of the coal materials
COAL-A

| | | |
|---|---|---|
| Quartz [SiO₂] | Pyrite [FeS₂] | Fluorapatite [Ca₅(PO₄)₃F] |
| Kaolin [Al₂Si₂O₅(OH)₄] | Calcium sulfide | Muscovite |
| | [see, Ref. 26] | [KAl₂(Si₃Al)O₁₀(F,OH)₂] |
| Montmorillonite | Albite [Na(AlSi₃O₈)] | Illite [KAl₂(Si₃Al)O₁₀(OH)₂] |
| [Na_{0.3}(Al,Mg)₂Si₄O₁₀(OH)₂•H₂O] | | |
| Jarosite [KFe₃(SO₄)₂(OH)₆] | Siderite [FeCO₃] | Dolomite [CaMg(CO₃)₂] |

COAL-D

| | | |
|---|---|---|
| Kaolin [Al₂Si₂O₅(OH)₄] | Quartz [SiO₂] | Pyrite [FeS₂] |
| Muscovite [KAl₂(Si₃Al)O₁₀(OH)₂] | Calcite [CaCO₃] | Illite [KAl₂(Si₃Al)O₁₀(OH)₂] |

COAL-E

| | | |
|---|---|---|
| Quartz [SiO₂] | Bassanite [CaSO₄•2H₂O] | Kaolin [Al₂Si₂O₅(OH)₄] |
| Illite [KAl₂(Si₃Al)O₁₀(OH)₂] | Calcium sulfide | Muscovite |
| | [see, Ref. 26] | [KAl₂(Si₃Al)O₁₀(F,OH)₂] |
| Dolomite [CaMg(CO₃)₂] | Hematite [Fe₂O₃] | |

It is evident from this analysis that the coal materials have a wider range of mineral chemistry than the basic oxides reported in the proximate analysis, detailed above. Through the use of both SiroQuant and XPert XRD analysis software a multitude of mineral phases were identified in these LTA samples. Table 3, above, highlights the range of mineral phases found in these LTA residues.

Quartz and anatase were the only significant oxide phases found in the LTA samples. This result is strongly supported by a recent study [see, Ref. 27] that also determined that the only significant oxides found in a compilation of LTA results were quartz (SiO₂) and anatase (TiO₂). This result illustrates that testing the effects of coal contaminants as they are likely to be introduced to the DCFC requires addition of the significant mineral phases and not their oxide counterparts.

### Graphite Performance, Stability and Reproducibility

In order to determine the performance of graphite as a baseline pressed pellet in the novel electrode design, several test methods were used to confirm its oxidative performance and reproducibility without addition of electrode contaminants. The graphite working electrode (prepared using procedure outlined above) was used in the assembled test cell along with the graphite rod counter and reference electrodes with the standard carbonate eutectic.

Due to the sacrificial nature of the carbon electrode pellet fabricated, it was determined to be important to test the continued electrochemical performance over a series of successive electrochemical sweeps. This was done to ensure no degradation in performance occurred for the time frame required to perform electrochemical testing.

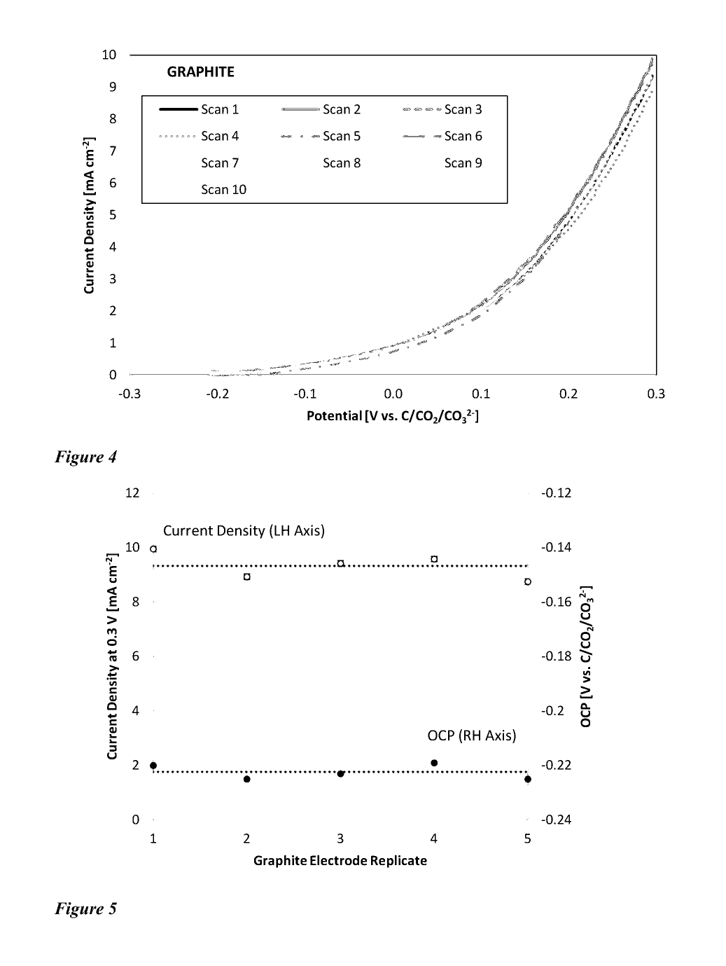

Once the cell was prepared, as shown in FIG. 2, it was heated to 500° C. and allowed to equilibrate for 30 minutes. Following equilibration, numerous sweeps were made over the selected potential range; i.e., from the open circuit potential (OCP) of the cell to 0.5 V above the OCP versus the C/CO₂/CO₃²⁻ reference. A scan rate of 5 mV/s was employed over a 30 minute period. This equated to ten consecutive potential sweeps with a 60 second rest interval between each scan. The anodic response over the course of this experiment is shown in FIG. 4.

FIG. 4 shows almost identical i-V curves for each repeated scan, indicating that the electrochemical behaviour using a graphite solid anode is reproducible and consistent over multiple scans. There is a small amount of variation seen in the i-V curves, most likely due to changes in the electrode surface from consumption of the carbon material from each successive potential sweep. Since the oxidation does not depend on the mass transport of carbon to the electrode surface as with particulate type cells, no mass transport limitations are observed in FIG. 4. This also suggests the diffusion of the CO₃²⁻ species from the electrolyte bulk to the electrode-electrolyte interface is not limiting since, in the half cell system, the anodic reaction also depends on the presence of carbonate, i.e.,

C+2CO₃²⁻→3CO₂+4e⁻ ANODE (4)

The diffusion coefficients of the carbonate anion, 0.85-1.92×10⁻⁵ cm²s⁻¹, in mixed alkali salts under various thermal conditions are reported in a wide range of literature [see, Refs. 28-31]. However, within the electrochemical environment, i.e., under conditions where there exists a potential gradient, the diffusivity of ions can behave significantly different. Costa, et al., [see, Ref. 32] report, on average, a 40% increase in the diffusion coefficient for the CO₃²⁻ ions in mixed alkali carbonate molten salts under an applied potential gradient. These authors further report diffusion coefficients in the range of 3.0-4.7×10⁻⁵ cm²s⁻¹. This significant increase in diffusivity, coupled with the fact that the carbonate ionic species constitute near 33% of the mole fraction of the molten electrolyte, accounts for the lack of diffusion limited behaviour despite quiescent conditions within the cell. The reaction is therefore kinetically limited.

In order to confirm the repeatability of experiments where minor differences in the preparation of the working electrode (resulting from differences in grinding, pelletising and surface treatment of graphite) could occur, several electrodes were fabricated using identical methods and tested in the half cell system. The electrochemical test procedure used included determination of the open circuit potential of the system and three subsequent linear sweeps at 5 mV/s to +0.5 V of the OCP measured (a wait time of 60 seconds was used between scans, similar to that of FIG. 4). The OCP and maximum current density at 0.3 V vs. C/CO₂/CO₃²⁻ (average of three sweeps conducted) for each electrode replicate are shown in FIG. 5.

It can be seen in FIG. 5 that the electrochemical results from electrodes manufactured from the same carbon source gave reproducible and consistent results. The average OCP was found to be −0.224±0.003 V vs. C/CO₂/CO₃²⁻ with current density at 0.3 V averaging 9.33±0.49 mA cm⁻². This is despite possible small deviations in the final surface topography which may result from the manual electrode preparation method used.

Results shown in FIG. 4 and FIG. 5 show good electrochemical reproducibility and stability for a graphite electrode base across which further contamination studies can be performed.

### Selective Contamination of Graphite Electrode

From XRD and proximate analysis results (see, above) on the original coal samples used in this study, and their low temperature residues, it was evident that quartz, clay (kaolin and montmorillonite in particular) and pyrite were amongst the more commonly found contaminant mineral phases. Mineral phases also present in high concentrations in the high temperature ash analysis (see, Table 2) include anatase and alumina, which were also selected for contamination studies.

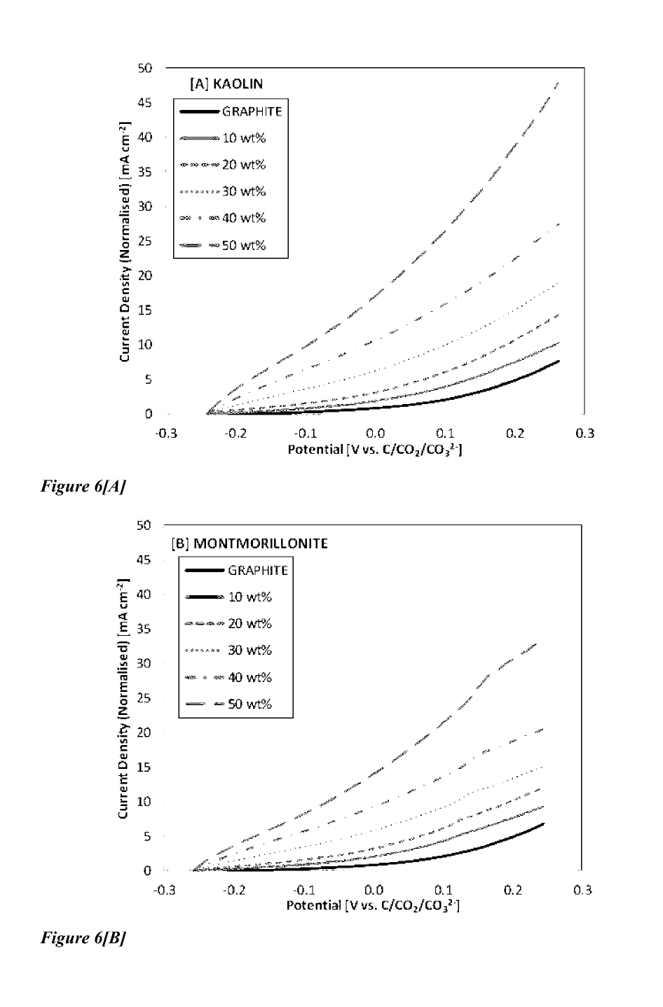

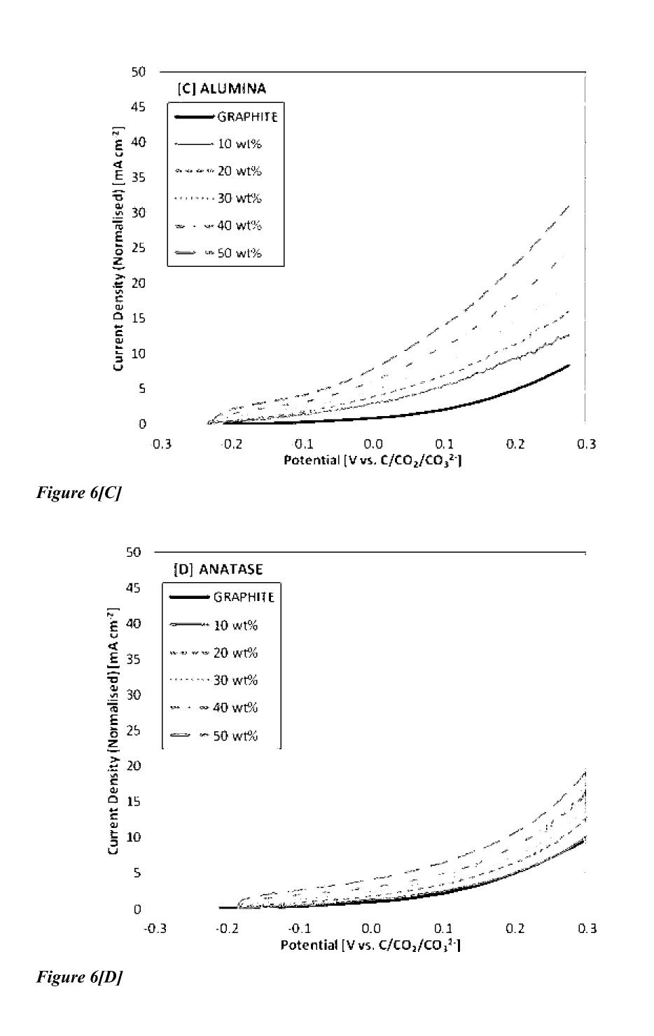

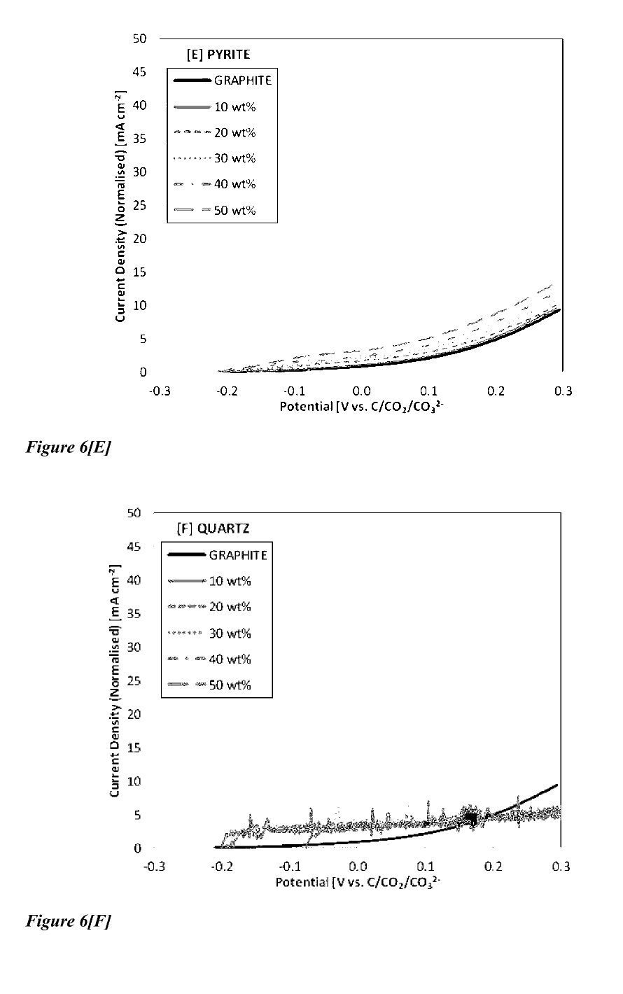

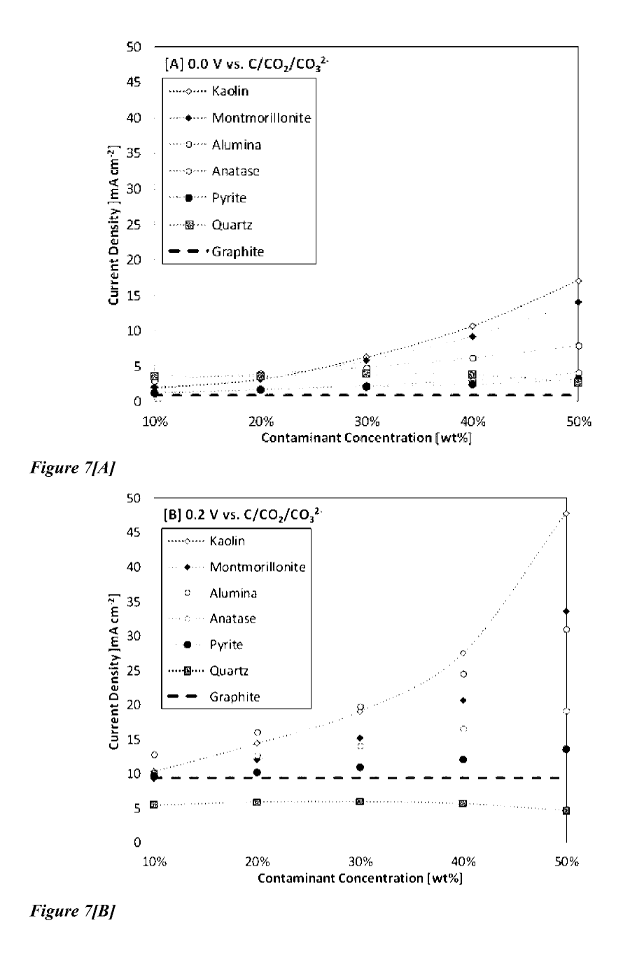

Contaminant concentrations between 10-50 wt. % with graphite were tested using the same electrochemical procedure as described for FIG. 4 and FIG. 5 with the third consecutive LSV used as a representative scan. Results for all contaminants tested with various contaminant loadings are shown in FIG. 6 with a comparison of the achievable current density at two different applied potentials included in FIG. 7.

Current density has been normalised in FIG. 6 and FIG. 7 to reflect the relative surface area of active graphite present at the electrode surface for each contaminant loading. As the amount of contaminant increases, the active area available for electrochemical oxidation decreases and therefore the reaction occurs on a reduced surface area (contaminants are assumed to be electrochemically inactive in the potential range investigated). The normalisation was carried out by calculating the volumetric weighting of each contaminant based on their density and the density of solid graphite.

The geometric surface area used to normalise current per unit area was then changed to reflect the relative volumetric proportion of carbon present. This enables assessment of the current produced per unit area of graphite rather than the total surface area exposed to electrolyte.

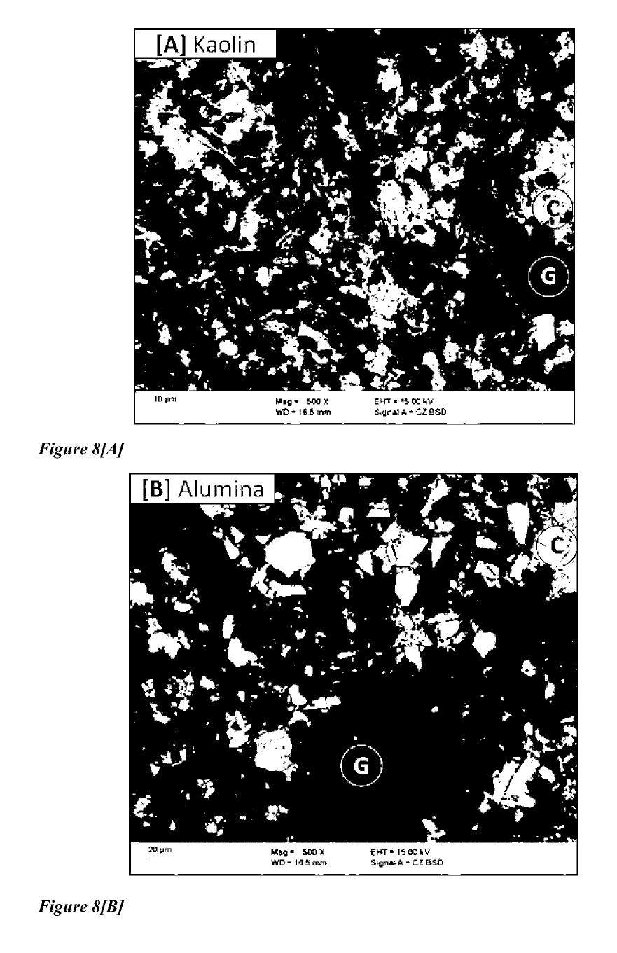

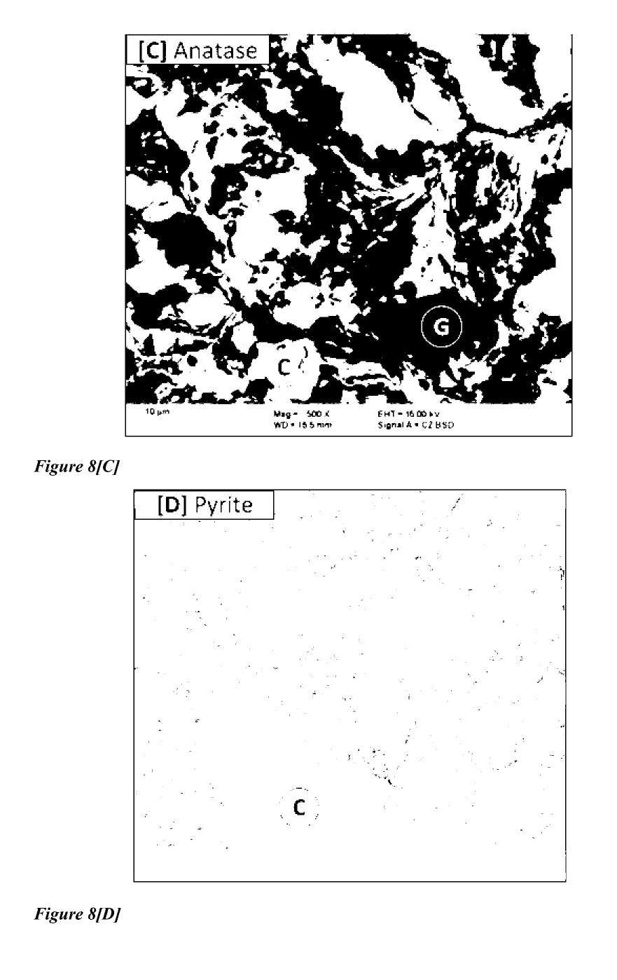

SEM was carried out on the surface of each electrode material prior to electrochemical testing in order to confirm homogenisation at the electrode surface and the normalisation method used. Results, shown in FIG. 8 show some differences in the distribution of contaminants within the graphite electrode.

A 500× magnification was used in each case for comparison of the contaminant phases. SEM images of the surface of the 50 wt. % contaminated electrodes confirm that the contaminants are intimately mixed within the graphite material in all cases. However, clear differences in the surface structure are observed dependent on the type of contaminant used.

Kaolin (see, FIG. 8[A] appears to be the most intimately mixed of the contaminants with high dispersion in the graphite. It can be seen that the kaolin contaminant has a particle size in the range of 3-8 μm. However, due to some agglomeration, some kaolin rich domains can be as large as 25 μm. It is likely that the conversion of the kaolin to metakaolin caused a reduction in the particle size and the hardness of the kaolin material. These, is turn, result in a more finely and evenly dispersed contaminant from the milling step used to introduce the contaminant into the graphite. Very similar results to that of kaolin were found for montmorillonite.

Quartz and alumina (see, FIGS. 8[E] and 8[B], respectively) appear to be similar in particle size and dispersion, although more graphite rich areas are observed in the case of the alumina. These particulates have a distribution of particle sizes from 4-5 μm up to ˜45 μm, although average particle sizes appear to reside mostly in the 10-20 μm range.

The anatase contaminant formed larger agglomerated regions, as well as small finely divided particles (see, FIG. 8[C]). It is probable that the “marbling” type effect seen in the SEM images is a result of the preparation method used for the SEM.

Preparations of the surface of the electrode for the SEM required wet polishing with a very fine abrasive, which would tend to remove the softer graphite material more easily from the surface and smear the anatase into the resulting cavities and clefts. What is evident from the SEM images of the anatase contaminated electrode is the clear difference between a contaminant phase that is significantly smaller than the graphite phase percolating through the graphite particles, rather than the graphite particles percolating through the contaminant phase.

Pyrite shows the largest relative particle sizes and therefore the lowest contact between the graphite and contaminant. Pyrite was one of the hardest contaminants (6.5-7 mohs scale) and the grinding process used to reduce the particle size of the pyrite material resulted in a large range of particle sizes varying from 3-32 μm with a large incidence of particles in the upper range. As a consequence, the pyrite contaminant was expected to have a larger non-uniform particle size distribution compared to the other contaminants within the working electrodes.

The normalisation technique used is therefore thought to over-represent graphite in the case of anatase (current density is likely larger than appears) while under-representing graphite in the case of pyrite addition (current density is likely smaller than shown through normalisation), however, in the majority of cases it is a good approximation for determining the active surface area. It can be seen from FIG. 6 and FIG. 7 that with this normalisation, addition of contaminants to electrodes have a significant effect on the reaction which generally increases with additions of the contaminant.

### Contamination of Carbonate Electrolyte

Complementary to studying the electrochemical effects of contaminating the graphite working electrode, contamination of the electrolyte was also undertaken leaving the anode as solid (undoped) graphite. The electrolyte was then purposefully contaminated with kaolin, montmorillonite, anatase, alumina, pyrite and quartz.

Contamination studies were performed for the addition of both 1 and 5 wt. % of contaminant to the electrolyte. The same electrochemical procedure as previously described above was used to evaluate electrochemical performance of the graphite in the presence of the now liquid phase-based coal-based contaminants.

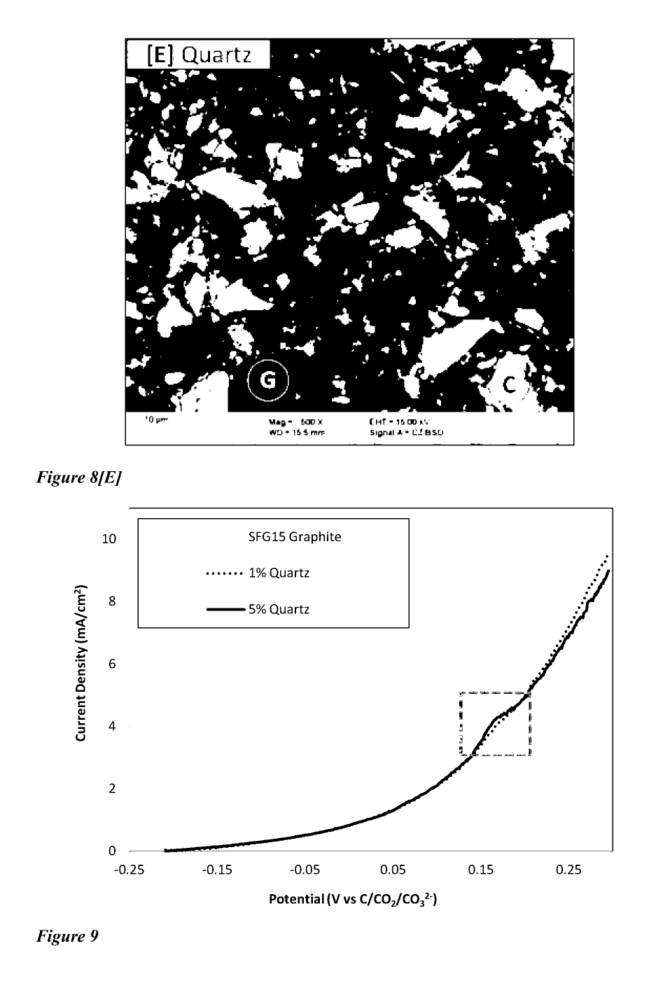

In contrast to addition of contaminants to the electrode, it was found that for almost all contaminants tested in the electrolyte no discernible change in the current response was seen for graphite electro-oxidation. Differences between LSV curves obtained were no more than normal variation in electrode fabrication procedure as shown in FIG. 5. The only contaminant which did show a small change in LSV behaviour was the quartz contaminant. Both the 1 and 5 wt. % contaminant loadings had an effect on the i-V curve from the graphite working electrode at a scan rate of 5 mV/s, as shown in FIG. 9.

A distinctive feature that can be seen in FIG. 9, in the i-V curves of the quartz-contaminated electrolyte is the emergence of a peak in the current response in the 0.12-0.19 V region, indicating another oxidative process occurring at the electrode surface. Following this peak a discernible decrease in the normalised current response was observed, most noticeably in the 5% contaminated electrolyte. This decrease is not significant compared to changes observed on the addition of contaminants instead to the solid electrode.

### Technical Significance of Results

The results show a clear interaction of incorporated contaminants with the graphitic carbon in the case of close physical contact, i.e., combined in a solid electrode. The order of activity for contaminants tested shows increased oxidative activity in the order of kaolin>montmorillonite>alumina>anatase>pyrite. Quartz was the only contaminant tested which showed a clear decrease in the oxidative activity of the graphite. The same effects are not observed in the case of other contaminant additions and increased effects are observed for increasing inclusion of contaminants.

A similar response to increasing contaminant concentration can be observed for each contaminant added at both low and high potentials with deviations observed at higher contaminant concentrations for kaolin and montmorillonite which increase beyond the response observed from other contaminants.

The largest enhancement observed for anode contamination was for the pre-treated kaolin, which was also shown to have the most intimate contact with graphite on mixing (see, FIG. 8[A]). Clear activation of the reaction occurs with increasing kaolin and montmorillonite concentrations, which is especially evident at concentrations>30 wt. % in the low potential range (see, FIG. 7[A]) where an apparent activation of the oxidation reaction takes place.

The cause of the activation is difficult to determine, although some authors have previously postulated ways in which the anodic oxidation of carbon could be altered mechanistically. For example, the contaminant phase could act as a mediating site for the exchange of O²⁻ species, and possibly catalyse the reaction where the phases meet. Both Li, et al., [see, Ref. 3] and Wang, et al., [see, Ref. 16] have noted an enhancement on the performance of their test cell when specific metal oxides were introduced to the electrolyte. Li, et al., attributed the performance enhancement observed for different carbon sources tested to an increase in surface oxides within the carbon phase [see, Ref. 3]. Both kaolin and montmorillonite contain surface oxides [see, Ref. 26] and it is possible the oxides within these structures facilitate the adsorption of O²⁻ to the electrode surface and subsequent reaction with neighbouring carbon particles.

Alternatively, the catalytic effect of the contaminants could be a result of contact between the molten electrolyte and the carbon surface. Kaolin and montmorillonite give the biggest performance enhancement when incorporated in high concentrations and were also observed to have the greatest degree of mixing and contact between the graphite and contaminants (see, FIG. 8[A]).

Contaminant addition may enable more intimate contact between the molten electrolyte and the carbon by changing the wettability of the electrode surface in regions where the contaminant phase is present. Contact between carbon and carbonate electrolyte was identified as a possible limitation by Chen, et al., [see, Ref. 33] and was discussed as a possibly limiting issue in a recent review paper [see, Ref. 7].

Overall, the effect of the inclusion of quartz to the electrode surface is the most dramatic result since it appeared to almost completely inhibit the oxidation of the graphite present at high potentials (see, FIG. 7[B]). Given the soluble nature of quartz in the molten carbonate electrolyte [see, Ref. 34] it is possible that the quartz contaminant is dissolving and forming a passivating layer at the electrode surface which reduces the CO₃²⁻ ion concentration in a localised area.

Li₂CO₃+SiO₂→Li₂SiO₃+CO₂ ΔG=−88.48 kJ/mol (5)

Na₂CO₃+SiO₂→Na₂SiO₃+CO₂ ΔG=−46.48 kJ/mol (6)

K₂CO₃+SiO₂→K₂SiO₃+CO₂ ΔG=−39.43 kJ/mol (7)

Devyatkin, et al., [see, Ref. 34] proposed a series of chemical equilibria that were possible within a molten tertiary eutectic carbonate/SiO₂ mixture, some of which are predicted to occur spontaneously and under non-electrolytic conditions. The reactions proposed by Devyatkin between the SiO₂ and the molten carbonate (see, Equations (5)-(7), above), mean that the intermediate species M₂SiO₃ (where M=Li, Na, K) could be present in the electrolyte at the electrode interface causing a different series of electrochemical reactions through which the carbon is oxidised.

An effect of the addition of quartz to the electrolyte was also observed (FIG. 9) in the form of a small oxidative peak in the 0.12-0.19 mV region. Other impurities were not seen to have any effect on the oxidation reaction of the graphite. Li, et al., [see, Ref. 3] reported a notable difference in electrochemical performance with the inclusion of only 8 wt. % SiO₂ on the basis of their carbon loading (which equates to 0.6 wt. % with respect to the molten carbonate electrolyte), although subtle electrochemical impacts were not able to be observed due to the particulate carbon used for oxidation. This feature in quartz contaminated carbon sources is not discussed in literature relating to coal and utilisation in the DCFC such as Li, et al., [see, Ref. 3], Cherepy, et al., [see, Ref. 17] and Vutetakis, et al., [see, Ref. 19], and is likely overshadowed by mass transport limitations of the cells used in these studies.

Devyatkin, et al., [see, Ref. 34] studied the electrochemical behaviour of SiO₂ in carbonate melts utilising, amongst other electrode types, a glassy carbon electrode. On glassy carbon, the emergence of a peak is seen in the same region of the anodic voltammogram (correcting for reference electrode used and cell temperatures).

Furthermore, Devyatkin, et al., reported no corresponding cathodic process on the working electrode during the reverse potential sweep, indicating that the process is either non-reversible or kinetically very slow. It is suggested from the literature that the process, giving rise to the peak in the anodic sweep is due to the electrochemical oxidation of silicon carbide, which is thought to form chemically at the electrode surface during the heat-up procedure. Devyatkin further confirmed this with a series of experiments in which the carbon content was increased within the molten electrolyte, with reports of forming a black α-SiC coating on the working electrode. This effect could be due to the passivation of the reactive sites of the graphite surface due to SiO₂ formation.

Effects of other contaminants were not observed, contrary to results of other authors adding metal oxides to the carbonate melt [see, Refs. 3, 16]. Possibly the quiescent nature of the cell used had an effect in this investigation for both the kaolin and montmorillonite since both the clay materials precipitated from the electrolyte, forming a solid deposit on the cell bottom and preventing the materials from coming in contact with the electrode surface.

The method and cell layout developed is shown to be effective to identifying the electrochemical effect of contaminants on a model fuel source in selected molten media. The method could further be applied in a range of applications including in the effect of contaminants present in waste derived carbon fuels and in other molten media such as sodium hydroxide and ionic liquids.

A method is provided by the present invention which shows an ability to observe and analyse the impact of various contaminants on the oxidation reaction of carbon in a direct carbon fuel cell. This method was used to demonstrate that the inclusion of coal contaminants to the solid electrode working electrode area had a significant effect on the oxidation mechanism of a graphitic carbon model fuel and indicates the interaction and importance of coal ash on the expected performance of different coals in the direct carbon fuel cell.

Clay materials appear to act as a catalyst for the oxidation of graphitic carbon while quartz can severely inhibit oxidative behaviour of the carbon. Further, it was found that small concentrations of specific ash components, when added to the carbonate electrolyte of a DCFC do not adversely impact on the oxidation reaction, although the addition of quartz will result in an additional electrochemical response within the cell.

Although the invention has been described with reference to specific examples it will be appreciated by those skilled in the art that the invention may be embodied in many other forms. For instance, graphite electrodes, as exemplified, represent a particularly preferred form of carbon electrodes, to which the present invention is more generally directed.

In this document and in its claims, reference to an element by the indefinite article “a” or “an” does not exclude the possibility that more than one of the elements is present, unless the context clearly requires that there be one and only one of the elements. The indefinite article “a” or “an” thus, usually means “at least one”.

### REFERENCES

[1] S. Giddey, S. P. S. Badwal, A. Kulkarni and C. Munnings, Progress in Energy and Combustion Science, 2012, 38, 360-399.
[2] X. Li, Z. H. Zhu, R. De Marco, J. Bradley and A. Dicks, J. Phys. Chem. A, 2010, 114, 3855-3862.
[3] X. Li, Z. H. Zhu, R. De Marco, J. Bradley and A. Dicks, Journal of Power Sources, 2010, 195, 4051-4058.
[4] R. D. Weaver, N.T.I. Service and U.S.N.T.I. Service, Direct Electrochemical Generation of Electricity from Coal: Quarterly Progress Report, Stanford Research Institute, 1979.
[5] A. C. Rady, S. Giddey, S. P. S. Badwal, B. P. Ladewig and S. Bhattacharya, Energy Fuels, 2012, 26, 1471-1488.
[6] D. Cao, Y. Sun and G. Wang, Journal of Power Sources, 2007, 167, 250-257.
[7] T. M. Gür, Chemical Reviews, 2013, 113, 6179-6206.
[8] X. Y. Xu, W. Zhou, F. L. Liang and Z. H. Zhu, Int. J. Hydrog. Energy, 2013, 38, 5367-5374.
[9] L. Guo, J. M. Calo, E. DiCocco and E. J. Bain, Energy Fuels, 2013, 27, 1712-1719.
[10] A. Elleuch, J. Yu, A. Boussetta, K. Halouani and Y. Li, Int. J. Hydrog. Energy, 2013, 38, 8514-8523.
[11] B. Cantero-Tubilla, C. C. Xu, J. W. Zondlo, K. Sabolsky and E. M. Sabolsky, Journal of Power Sources, 2013, 238, 227-235.
[12] A. Kulkarni, S. Giddey and S. P. S. Badwal, Solid State Ion., 2011, 194, 46-52.
[13] Y. Nabae, K. D. Pointon and J. T. S. Irvine, Journal of the Electrochemical Society, 2009, 156, B716-B720.
[14] G. A. Hackett, J. W. Zondlo and R. Svensson, Journal of Power Sources, 2007, 168, 111-118.
[15] Y. Nabae, K. D. Pointon and J. T. S. Irvine, Energy Environ. Sci., 2008, 1, 148-155.
[16] C. Q. Wang, J. Liu, J. Zeng, J. L. Yin, G. L. Wang and D. X. Cao, Journal of Power Sources, 2013, 233, 244-251.
[17] N. J. Cherepy, R. Krueger, K. J. Fiet, A. F. Jankowski and J. F. Cooper, Journal of the Electrochemical Society, 2005, 152, A80-A87.
[18] X. Li, Z. H. Zhu, R. De Marco, A. Dicks, J. Bradley, S. M. Liu and G. Q. Lu, Ind. Eng. Chem. Res., 2008, 47, 9670-9677.
[19] D. G. Vutetakis, D. R. Skidmore and H. J. Byker, Journal of the Electrochemical Society, 1987, 134, 3027-3035.
[20] S. S. J. Warne, Thermochimica Acta, 1996, 272, 1-9.
[21] K. E. Benfell, B. B. Beamish and K. A. Rodgers, Thermochimica Acta, 1996, 286, 67-74.
[22] F. J. Maldonado-Hódar, J. Rivera-Utrilla, A. M. Mastral-Lamarca and M. A. Ferro-García, Fuel, 1995, 74, 818-822.
[23] F. Moodi, A. A. Ramezanianpour and A. S. Safavizadeh, Scientia Iranica, 2011, 18, 906-912.
[24] G. J. Janz and M. R. Lorenz, Journal of Chemical and Engineering Data, 1961, 6, 321-323.
[25] L. Lu, V. Sahajwalla, C. Kong and D. Harris, Carbon, 2001, 39, 1821-1833.
[26] M. Castellano, A. Turturro, P. Riani, T. Montanari, E. Finocchio, G. Ramis and G. Busca, Applied Clay Science, 2010, 48, 446-454.
[27] C. R. Ward, International Journal of Coal Geology, 2002, 50, 135-168.
[28] T. Koishi, S. Kawase, S. Tamaki and T. Ebisuzaki, Journal of the Physical Society of Japan, 2000, 69, 3291-3296.
[29] J. P. Hansen and I. R. McDonald, Journal of Physics C-Solid State Physics, 1974, 7, L384-L386.
[30] G. J. Janz, Molten Salts Handbook, Academic Press, New York, 1967.
[31] P. L. Spedding and R. Mills, Journal of the Electrochemical Society, 1965, 112, 594-&.
[32] M. F. Costa, Journal of Molecular Liquids, 2008, 138, 61-68.
[33] M. Chen, C. Wang, X. Niu, S. Zhao, J. Tang and B. Zhu, Int. J. Hydrog. Energy, 2010, 35, 2732-2736.
[34] S. V. Devyatkin and A. D. Pisanenko, Russian Journal of Applied Chemistry, 2002, 75, 562-564.

What is claimed is:

1. Use of a dopant selected from the group consisting of kaolin, montmorillonite, alumina, anatase and pyrite for incorporation within a solid carbon working electrode, for the enhancement of anodic oxidation within an electrochemical half cell.

2. Use according to claim 1, wherein the electrochemical half cell is resident within a direct carbon fuel cell (DCFC), the anodic oxidation therefore being of the carbon working electrode.

3-6. (canceled)

7. Use according to claim 1, wherein the relative proportion of the dopant is between about 10 wt. % to about 50 wt. %.

8. Use according to claim 1, wherein the dopant is kaolin or montmorillonite.

9. (canceled)

10. Use according to claim 1, wherein the dopant is pre-treated by heating at approximately 500° C. for approximately 30 minutes prior to pelleting, so as to mitigate against possible mechanical damage to the resultant pellets as a result of dehydroxylation of kaolin to metakaolin under half cell conditions.

11. Use according to claim 5, wherein the pre-treated kaolin dopant is present in substantially >30 wt %, and wherein the potential is relatively low (e.g., 0.2 V vs. C/CO₂/CO₃²⁻), thereby to provide for an oxidative enhancement of the order of 45-50 mA cm⁻².

12. Use of a quartz dopant for incorporation within a solid carbon working electrode, for the inhibition of anodic oxidation within an electrochemical half cell.

13-15. (canceled)

16. Use according to claim 7, wherein the relative proportion of the dopant is between about 10 wt. % to about 50 wt. %.

17. A solid carbon working electrode for incorporation within an electrochemical half cell, the electrode being doped with a dopant selected from the group consisting of kaolin, montmorillonite, alumina, anatase and pyrite, thereby to provide for an enhancement of anodic oxidation within the half cell.

18. An electrode according to claim 17, wherein the electrochemical half cell is resident within a direct carbon fuel cell (DCFC), the anodic oxidation therefore being of the carbon working electrode.

19-22. (canceled)

23. An electrode according to claim 10, wherein the relative proportion of the dopant is between about 10 wt. % to about 50 wt. %.

24. An electrode according to claim 10, wherein the dopant is kaolin or montmorillonite.

25-27. (canceled)

28. A solid carbon working electrode for incorporation within an electrochemical half cell, the electrode being doped with quartz, thereby to provide for an inhibition of anodic oxidation within the half cell.

29-32. (canceled)

33. A method of enhancing the efficiency of a direct carbon fuel cell (DCFC), the method comprising incorporating within the anodic half cell of the DCFC a solid carbon working electrode doped with a dopant selected from the group consisting of kaolin, montmorillonite, alumina, anatase and pyrite.

34. A method according to claim 33, wherein the electrochemical half cell is resident within a direct carbon fuel cell (DCFC), the anodic oxidation therefore being of the carbon working electrode.

35-38. (canceled)

39. A method according to claim 14, wherein the relative proportion of the dopant is between about 10 wt. % to about 50 wt. %.

40. A method according to claim 14, wherein the dopant is kaolin or montmorillonite.

41-43. (canceled)

44. A method of inhibiting the efficiency of a direct carbon fuel cell (DCFC), the method comprising incorporating within the anodic half cell of the DCFC a solid carbon working electrode doped with quartz.

45-48. (canceled)

49. A method of preparing a doped solid carbon electrode for use within an anodic half cell of a direct carbon fuel cell (DCFC), the method comprising grinding the solid carbon with a dopant selected from the group consisting of kaolin, montmorillonite, alumina, anatase, pyrite and quartz; and pelleting the resultant ground mixture.

50. (canceled)

51. A method according to claim 19, wherein the dopant is present within the doped electrode in an amount of about 10 wt. % to about 50 wt. %.

52. A method according to claim 19, further comprising a pre-treatment step, the pre-treatment step comprising heating the dopant at approximately 500° C. for approximately 30 minutes prior to pelleting.

53. A method according to claim 19, wherein the dopant is kaolin.

54. A method according to claim 22, wherein the kaolin is pre-treated by heating at approximately 500° C. for approximately 30 minutes prior to pelleting, so as to mitigate against possible mechanical damage to the resultant pellets as a result of dehydroxylation of kaolin to metakaolin under half cell conditions.

55. A doped solid carbon electrode when prepared by a method as defined according to claim 19.

56. (canceled)
